(19) United States
(12) Patent Application Publication
(10) Pub. No.: US 2025/0305328 A1
(43) Pub. Date: Oct. 2, 2025

(54) DOOR LATCH APPARATUS

(71) Applicant: MINEBEA MITSUMI Inc., Kitasaku-gun (JP)

(72) Inventors: Nobuya AKAGI, Hiroshima (JP); Kohei YAMASAKI, Hiroshima (JP); Hideto TAKENAKA, Hiroshima (JP)

(21) Appl. No.: 19/073,208

(22) Filed: Mar. 7, 2025

(30) Foreign Application Priority Data
Mar. 29, 2024 (JP) 2024-056615

(51) Int. Cl. E05B 77/26; E05B 77/02; E05B 81/06; E05B 81/16; E05B 81/30; E05B 81/64

(52) U.S. Cl. CPC E05B 77/26; E05B 77/02; E05B 81/06; E05B 81/16; E05B 81/30; E05B 81/64

(57) ABSTRACT

There is provided a door latch apparatus including a control unit that drives a motor for a locking mechanism and moves a lock plate from an unlocked position to a locked position when receiving, from a lock state detecting switch, a lock switching signal indicating that the lock plate has been moved from the locked position to the unlocked position in a child lock state in which the control unit has received a child lock signal from a child lock switch.

### CROSS REFERENCE TO RELATED APPLICATION

This application claims benefit of priority to Japanese Patent Application 2024-056615, filed Mar. 29, 2024, the entire content of which is incorporated herein by reference.

### BACKGROUND

### Technical Field

The present disclosure relates to a door latch apparatus.

### Background Art

A door latch apparatus for a vehicle described in JP 2009-052229 A includes a locking mechanism capable of switching between a state (unlocked state) in which manipulation of handles to open a door is active and a state (locked state) in which the manipulation of the handles is not active. Also, the door latch apparatus includes an override mechanism that causes the locking mechanism to be switched from the locked state to the unlocked state by manipulation of only an inner handle of the handles. Specifically, a transition from the locked state to the unlocked state can be performed by a first manipulation of the inner handle, and a latch mechanism can be unlatched by a second manipulation of the inner handle. Further, the door latch apparatus includes a child lock mechanism. When the child lock mechanism is in an active state, that is, in a child lock state, the override mechanism does not function and the locking mechanism is maintained in a locked state, and the latch mechanism is not unlatched and the door is not opened, even if the inner handle is operated.

### SUMMARY

In recent years, there has been an increasing demand for motorized child lock mechanisms. However, when a child lock mechanism is motorized, a dedicated motor separate from a motor for a locking mechanism needs to be provided. This results in an increase in the number of components and intricacy of a structure accordingly.

An object of the present disclosure is to motorize a child lock mechanism of a door latch apparatus while an increase in the number of components and intricacy of a structure accordingly are curbed.

An aspect of the present disclosure provides a door latch apparatus including: a fork that disengageably holds a striker; a claw that disengageably engages with the fork and enables an engaged state of the fork with the striker to be maintained; an inner opening lever that is rotatable in conjunction with a manipulation of an inner handle; a lock member movable between an unlocked position and a locked position; a motor for a locking mechanism which is capable of causing the lock member to be switched to either the unlocked position or the locked position; a lock member position detecting unit that directly or indirectly detects movement of the lock member from the locked position to the unlocked position and outputs a lock switching signal; a link that operates in conjunction with the lock member, transmits a rotation force of the inner opening lever to the claw to enable the claw and the fork to be disengaged from each other when the lock member is located at the unlocked position, and is not capable of transmitting the rotation force of the inner opening lever to the claw when the lock member is located at the locked position; an override mechanism that enables the lock member to be moved from the locked position to the unlocked position in response to rotation of the inner opening lever; a child lock manipulation receiving unit that receives a selecting manipulation selecting use or non-use of a child lock mechanism, outputs a child lock signal when the received selecting manipulation is use of the child lock mechanism, and outputs a child unlock signal when the received selecting manipulation is non-use of the child lock mechanism; and a control unit that is capable of receiving the child lock signal and the child unlock signal from the child lock manipulation receiving unit and capable of receiving the lock switching signal from the lock member position detecting unit. The control unit drives the motor for the locking mechanism and moves the lock member from the locked position to the unlocked position when the lock switching signal is received from the lock member position detecting unit in a child lock state in which the child lock signal has been received from the child lock manipulation receiving unit.

The inner opening lever rotates in conjunction with the manipulation of the inner handle, and this causes the override mechanism to move the lock member from the locked position to the unlocked position. However, when, in the child lock state in which the control unit has received the child lock signal from the child lock manipulation receiving unit, the override mechanism has moved the lock member from the locked position to the unlocked position, and thereby the control unit receives the lock switching signal from the lock member position detecting unit, the control unit drives the motor for the locking mechanism and moves the lock member from the unlocked position to the locked position. As described above, since the child lock mechanism is realized by control of the motor for the locking mechanism by the control unit, there is no need to provide a dedicated motor for the child lock mechanism. Hence, the child lock mechanism of the door latch apparatus can be motorized while an increase in costs due to an increase in the number of components and intricacy of a structure is curbed.

According to a door latch apparatus of the present disclosure, a child lock mechanism of the door latch apparatus can be motorized while an increase in the number of components and intricacy of a structure accordingly are curbed.

### BRIEF DESCRIPTION OF DRAWINGS

FIG. 1 is a block diagram illustrating a configuration of a door latch apparatus according to an embodiment of the present disclosure;

FIG. 2 is a schematic view illustrating, together with an override mechanism, a locking mechanism that also functions as a child lock mechanism (a locked state at the time of child unlock);

FIG. 3 is a schematic view illustrating, together with the override mechanism, the locking mechanism that also functions as the child lock mechanism (a first manipulation of an inner lever at the time of child unlock);

FIG. 4 is a schematic view illustrating, together with the override mechanism, the locking mechanism that also functions as the child lock mechanism (an end of the first manipulation of the inner lever at the time of child unlock);

FIG. 5 is a schematic view illustrating, together with the override mechanism, the locking mechanism that also functions as the child lock mechanism (a second manipulation of the inner lever at the time of child unlock);

FIG. 6 is a schematic view illustrating, together with the override mechanism, the locking mechanism that also functions as the child lock mechanism (a start of operation performed when a control unit has received an unlock state detection signal at the time of child unlock); and

FIG. 7 is a schematic view illustrating, together with the override mechanism, the locking mechanism that also functions as the child lock mechanism (an end of the operation performed when the control unit has received the unlock state detection signal at the time of child unlock).

### DETAILED DESCRIPTION

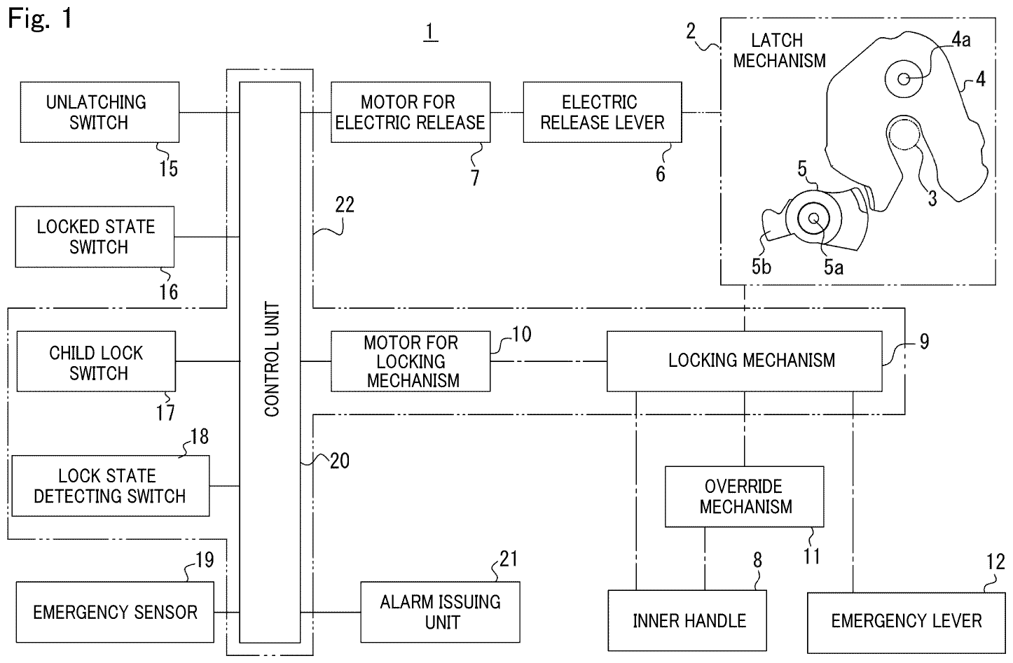

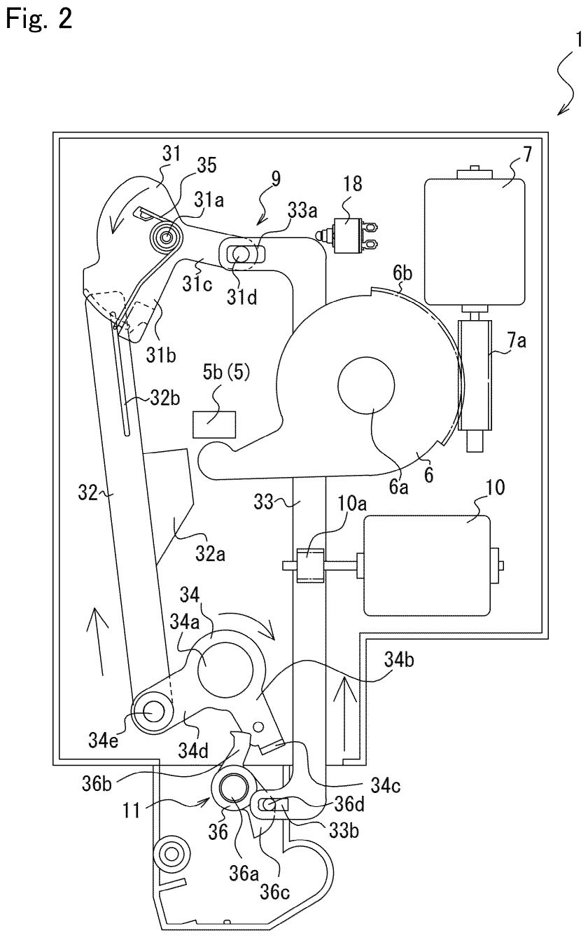

With reference to FIG. 1, a door latch apparatus 1 according to an embodiment of the present disclosure is provided for locking and unlocking a door of a motor vehicle which is an example of a vehicle. The door is provided with a latch mechanism 2. The latch mechanism 2 includes a fork 4 that disengageably holds a striker 3 provided in the vehicle body. The fork 4 is rotatable around a shaft 4a and is resiliently biased in a clockwise direction in FIG. 1. In addition, the latch mechanism 2 includes a claw 5 that can be disengaged from the fork 4 and can engage with the fork 4 to maintain an engagement state between the fork 4 and the striker 3. The claw 5 is rotatable around a shaft 5a and is resiliently biased in a counterclockwise direction in FIG. 1. When a manipulation portion 5b of the claw 5 is moved in the clockwise direction (upward in FIGS. 2 to 7 described below), the claw 5 can be disengaged from the fork 4.

The door latch apparatus 1 includes an electric release lever 6 that manipulates the manipulation portion 5b of the claw 5 to disengage the claw 5 from the fork 4, and a motor 7 for electric release that drives the electric release lever 6. The door latch apparatus 1 also includes a locking mechanism 9 that switches between an unlocked state in which the claw 5 can be disengaged from the fork 4 and a locked state in which the claw 5 cannot be disengaged from the fork 4, in response to a manipulation (pulling in the present embodiment) of an inner handle 8. The door latch apparatus 1 includes, in addition to the inner handle 8, a motor 10 for the locking mechanism, an override mechanism 11, and an emergency lever 12 as elements capable of manipulating the locking mechanism 9. Also, the door latch apparatus 1 includes an unlatching switch 15, a locked state switch 16, a child lock switch 17 (a child lock manipulation receiving unit), a lock state detecting switch (a lock member position detecting unit) 18, and an emergency sensor 19 as switches and sensors. Signals output from these switches and sensor are input to the control unit 20, and the control unit 20 controls the motor 7 for electric release and the motor 10 for the locking mechanism on the basis of the input signals. Also, the door latch apparatus 1 includes an alarm issuing unit 21.

The door latch apparatus 1 has an electric release function, an electric lock function, an override function, and a child lock function.

Regarding the electric release function, with reference to FIG. 1, when a rotation driving force of the motor 7 for electric release is transmitted to the electric release lever 6, and the electric release lever 6 is rotated, the manipulation portion 5b of the claw 5 is manipulated by the rotation of the electric release lever, and the claw 5 is disengaged from the fork 4. Specifically, the electric release lever 6 is rotatably supported by a shaft 6a. The electric release lever 6 has a gear portion 6b. The gear portion 6b engages with a worm gear 7a attached to an output shaft of the motor 7 for electric release. A rotation output of the motor 7 for electric release is transmitted to the electric release lever 6 via the worm gear 7a and the gear portion 6b, thereby rotating the electric release lever 6 so that the manipulation portion 5b of the claw 5 is manipulated to move upward in FIG. 1. The unlatching switch 15 receives an unlatching instruction manipulation by an occupant and outputs an unlatching signal. The control unit 20 having received the unlatching signal drives the motor 7 for electric release to rotate the electric release lever 6, thereby disengaging the claw 5 from the fork 4.

Regarding the electric lock function, when the locking mechanism 9 is driven to operate by the motor 10, switching between the unlocked state and the locked state of the locking mechanism 9 can be performed. The locked state switch 16 receives a lock instruction operation and an unlock instruction operation by the occupant and outputs a lock signal or an unlock signal. The control unit 20 that has received a lock signal or an unlock signal rotates the motor 10 for the locking mechanism to rotate in a rotation direction corresponding to any signal that has been received. Consequently, the locking mechanism 9 is switched to the locked state or the unlocked state as will be described below.

The override function is realized in cooperation between the override mechanism 11 and the locking mechanism 9. The override function enables the locking mechanism 9 to be switched from the locked state to the unlocked state in response to the manipulation of the inner handle 8 when the locking mechanism 9 is in the locked state. As will be described below, the override function in the present embodiment is a two-motion override mechanism that realizes the switching of the locking mechanism 9 from the locked state to the unlocked state and the disengagement of the claw 5 from the fork 4 in response to the manipulation of the inner handle 8 twice. The override function is disabled when the child lock function is active, that is, in a child lock state.

The child lock function is a function intended to prevent the door from being released in response to the manipulation of the inner handle 8 by an occupant such as a child. When the child lock function is not active, that is, in a child unlock state, the locking mechanism 9 can be switched from the locked state to the unlocked state by the override function. However, in the child lock state, the override function is disabled as described above, and the locking mechanism 9 cannot be switched from the locked state to the unlocked state in response to the manipulation of the inner handle 8.

A child lock mechanism 22 that realizes the child lock function includes the locking mechanism 9, the motor 10 for the locking mechanism, a child lock switch 17, and the lock state detecting switch 18. The child lock mechanism 22 is of an electric type in which the motor 10 for the locking mechanism is used as a power source. The motor 10 for the locking mechanism is used for operating the locking mechanism 9 as described above, and the child lock mechanism 22 does not include a dedicated motor for realizing the child lock function other than the motor 10 for the locking mechanism.

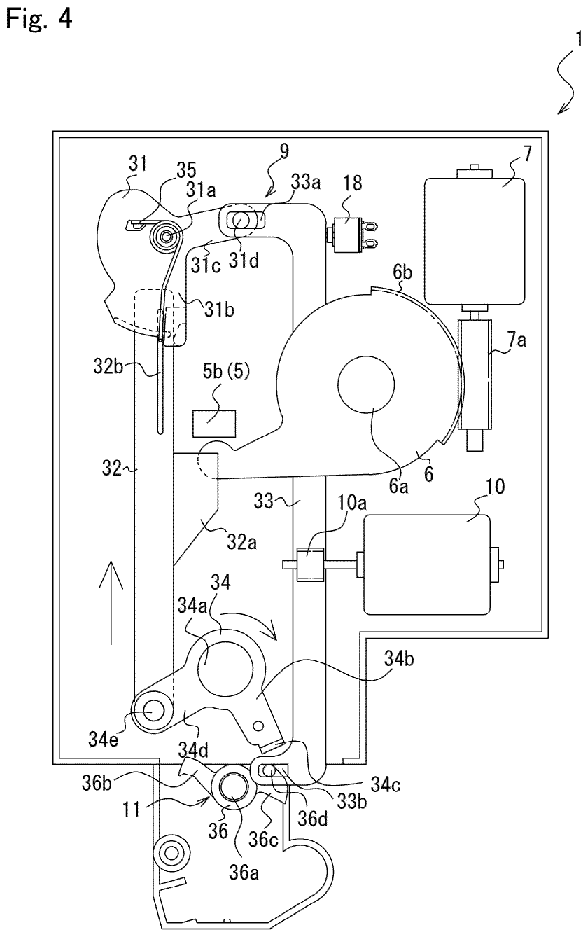

The locking mechanism 9 and the override mechanism 11 will be described with reference to FIGS. 2 and 4.

The locking mechanism 9 includes a lock plate (lock member) 31, a link 32, a joint 33, and an inner opening lever 34, in addition to the motor 10 for the locking mechanism described above.

The inner opening lever 34 is rotatable around a shaft 34a. The inner opening lever 34 rotates in conjunction with the pulling manipulation of the inner handle 8 in the clockwise direction in FIGS. 2 and 4. The inner opening lever 34 is resiliently biased in the counterclockwise direction by a spring (not illustrated). A manipulation portion 34c used for manipulating the override mechanism 11 is provided on one arm 34b of the inner opening lever 34. The other arm 34d of the inner opening lever 34 is connected to one end (a lower end in FIGS. 2 and 4) of the link 32 via a rotary joint 34e to be rotatable with each other.

The lock plate 31 is rotatable around a shaft 31a. The lock plate 31 includes an arm 31b overlapping the other end (an upper end in FIGS. 2 and 4) of the link 32 and an arm 31c overlapping one end (an upper end in FIGS. 2 and 4) of the joint 33. The arm 31b is connected to the other end of the link via a spring 35. Specifically, one end of the spring 35 is latched to the lock plate 31, and the other end of the spring 35 is inserted into a long groove hole 32b provided at the other end of the link 32 beyond a distal end of the arm 31b, and is movably held along the long groove hole 32b.

An output portion 32a used for manipulating the manipulation portion 5b of the claw 5 is provided on the link 32. When the output portion 32a pushes up the manipulation portion 5b due to upward movement of the link 32 in in FIGS. 2 and 4, the claw 5 is disengaged from the fork 4.

The joint 33 is held to be capable of performing only linear movement (movement in a vertical direction in FIGS. 2 and 4). A groove hole 33a extending in a horizontal direction is provided at one end (an upper end in FIGS. 2 and 4) of the joint 33. When a column-shaped pin 31d provided on the arm 31c of the lock plate 31 is inserted into the groove hole 33a, one end of the joint 33 is connected to the lock plate 31. When the joint 33 is lifted, the lock plate 31 is rotated in the counterclockwise direction, and when the joint 33 is lowered, the lock plate 31 is rotated in the clockwise direction. A groove hole 33b extending in the horizontal direction is also provided at the other end (a lower end in FIGS. 2 and 4) of the joint 33. As will be described below, an override lever 36 included in the override mechanism 11 is connected to the groove hole 33b.

The motor 10 for the locking mechanism can lift and lower the joint 33. Specifically, a gear 10a attached to an output shaft of the motor 10 for the locking mechanism engages with a gear portion (not illustrated) provided on the joint 33. The rotation output of the motor 10 for the locking mechanism is transmitted to the joint 33 via the gear 10a and the gear portion, and the joint 33 is lifted and lowered according to a rotation direction of the motor 10 for the locking mechanism.

FIG. 2 illustrates a locked state of the locking mechanism 9, that is, a state in which the lock plate 31 is located at the locked position, and FIG. 4 illustrates an unlocked state of the locking mechanism 9, that is, a state in which the lock plate 31 is located at the unlocked position. In the locked state, the link 32 and the manipulation portion 5b of the claw 5 are displaced in the horizontal direction in FIGS. 2 and 4, but in the unlocked state, the link 32 and the manipulation portion 5b of the claw 5 are aligned in the horizontal direction in FIGS. 2 and 4. As described above, the joint 33 is lifted and lowered according to the rotation direction of the motor 10 for the locking mechanism, thereby moving the lock plate 31 to the locked position or the unlocked position, and the locked state and the unlocked state of the locking mechanism 9 are switched. In the present embodiment, the lock plate 31 of the locking mechanism 9 can be switched from outside from the locked position to the unlocked position in response to the emergency lever 12 described above.

The override mechanism 11 includes an override lever 36. The override lever 36 is rotatable around a shaft 36a. One arm 36b of the override lever 36 is manipulated by the manipulation portion 34c of the inner opening lever 34 described above, and when the manipulation portion 34c pushes the arm 36b in response to the rotation of the inner opening lever 34 in the clockwise direction in FIGS. 2 and 4, the override lever 36 is rotated in the counterclockwise direction. A column-shaped pin 36d is provided on the other arm 36c of the override lever 36. By inserting the pin 36d into the groove hole 33b of the other end (the lower end in FIGS. 2 and 4) of the joint 33, the arm 36c of the override lever 36 and the other end of the joint 33 are connected to each other. When the override lever 36 is rotated in the counterclockwise direction, the joint 33 is lifted.

With continuous reference to FIGS. 2 and 4, the lock state detecting switch 18 which is an example of the lock member position detecting unit is in an OFF state when the locking mechanism 9 is in the locked state (FIG. 2), but is in an ON state in which the lock state detecting switch is pressed by the joint 33 when the locking mechanism 9 is in the unlocked state (FIG. 4), and outputs a lock switching signal indicating that switching of the locking mechanism 9 from the locked state to the unlocked state (movement of the lock plate 31 from the locked position to the unlocked position) has been detected, and the output lock switching signal is received by the control unit 20. As described above, the lock state detecting switch 18 of the present embodiment indirectly detects that the lock plate 31 has moved from the locked position to the unlocked position depending on a position of the joint 33. However, the lock state detecting switch 18 may directly detect the movement from the locked position to the unlocked position from the position of the lock plate 31, or may indirectly detect the movement of the lock plate 31 from the locked position to the unlocked position depending on the position or posture of the link 32.

The child lock switch 17 receives a selecting manipulation selecting use or non-use of the child lock mechanism 22 by an occupant, outputs a child lock signal when the received selecting manipulation is use of the child lock mechanism 22, and outputs a child unlock signal when the received selecting manipulation is non-use of the child lock mechanism 22. The control unit 20 receives the output child lock signal and child unlock signal.

The emergency sensor 19 detects an emergency situation in which a manipulation of the inner handle 8 needs to ensure disengagement of the claw 5 from the fork 4, and outputs an emergency signal. The emergency signal is received by the control unit 20. Examples of the emergency situation to be detected by the emergency sensor 19 include, for example, collision of the vehicle with another vehicle or an obstacle, submersion of the vehicle, and a decrease in remaining vehicle battery life.

The alarm issuing unit 21 is controlled by the control unit 20 and issues an alarm that can be recognized by the occupant, such as sound, image, or vibration. Hereinafter, operations of the door latch apparatus 1 when the inner handle 8 is operated will be described.

First, switching of the locking mechanism 9 by the override mechanism 11 in the child unlock state, that is, in a case where a child unlock signal is output from the child lock switch 17 to the control unit 20 will be described.

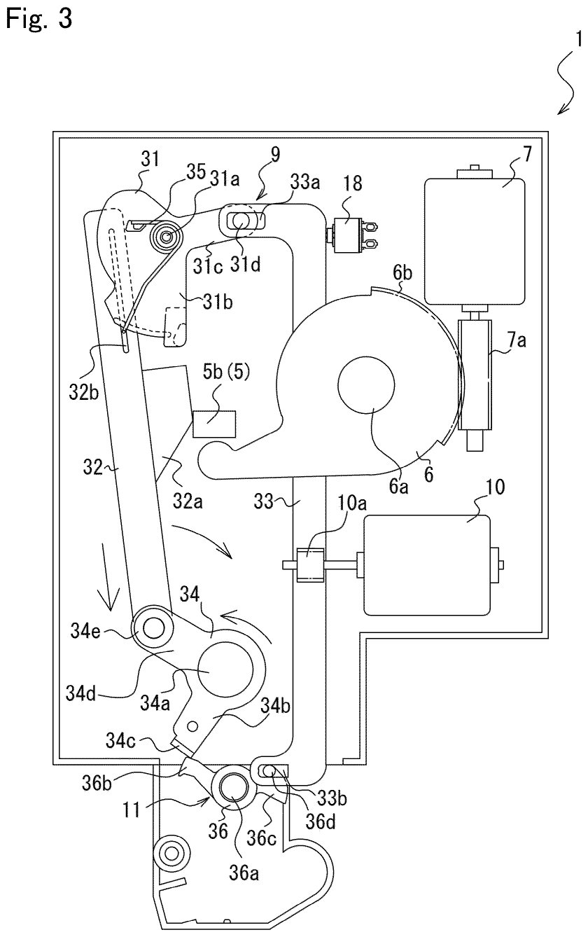

With reference to FIG. 2, when a first pulling manipulation of the inner handle 8 is performed in a case where the locking mechanism 9 is in the locked state, the inner opening lever 34 is rotated in the clockwise direction, and the link 32 is moved obliquely upward in conjunction therewith. In response to the rotation of the inner opening lever 34 in the clockwise direction, the manipulation portion 34c of the inner opening lever 34 pushes and rotates the arm 36b of the override lever 36 in the counterclockwise direction. Also, in response to the rotation of the override lever 36, the joint 33 is lifted. As a result, as illustrated in FIG. 3, the lock plate 31 is rotated in the counterclockwise direction by the joint 33, and the lock plate 31 is moved from the locked position to the unlocked position. Also, in the state of FIG. 3, the output portion 32a of the link 32 interferes with the manipulation portion 5b of the claw 5.

When the first pulling manipulation of the inner handle 8 is stopped in the state of FIG. 3, the inner opening lever 34 is rotated in the counterclockwise direction by a resilient biasing force, and the link 32 is lowered in response to the rotation thereof. Also, when the link 32 is lowered, interference between the output portion 32a and the manipulation portion 5b of the claw 5 is eliminated, and the link 32 is rotated in the clockwise direction around the rotary joint 34e. As a result, as illustrated in FIG. 4, the lock plate 31 is located at the unlocked position, and the output portion 32a is aligned with the manipulation portion 5b of the claw 5 in the horizontal direction in FIG. 4, that is, in the unlock state.

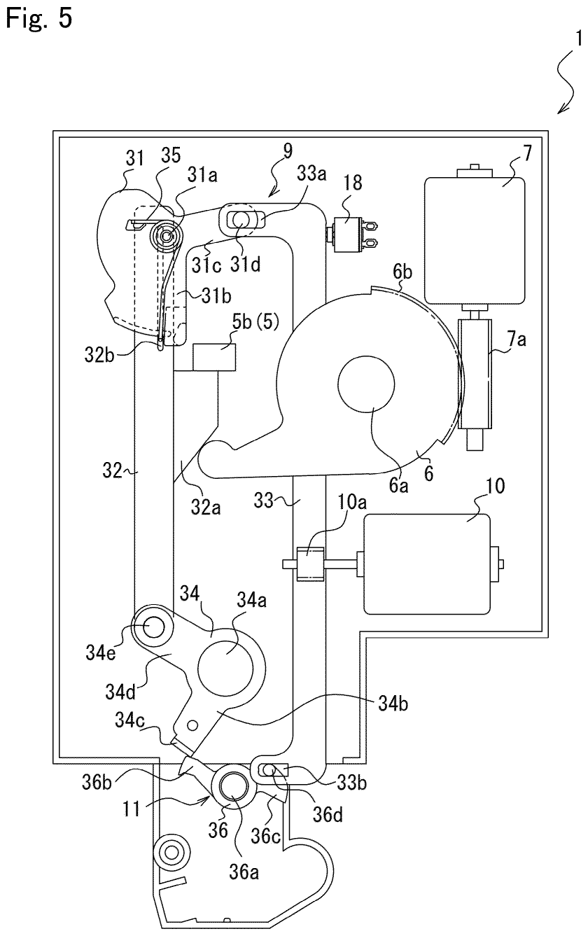

When a second pulling manipulation of the inner handle 8 is performed in the unlocked state of FIG. 4, the inner opening lever 34 is rotated in the clockwise direction, and the link 32 is moved upward in conjunction with the rotation of the inner opening lever 34. As a result, as illustrated in FIG. 5, the output portion 32a of the link 32 pushes up the manipulation portion 5b of the claw 5, and the claw 5 is disengaged from the fork 4.

Next, operations in the child lock state, that is, in a case where a child lock signal is output from the child lock switch 17 to the control unit 20 will be described.

With reference to FIG. 2 again, when the first pulling manipulation of the inner handle 8 is performed in a case where the locking mechanism 9 is in the locked state, the inner opening lever 34 is in conjunction with the rotation in the clockwise direction so that the link 32 is moved obliquely upward, the joint 33 is lifted in response to the rotation of the override lever 36. As a result, as illustrated in FIG. 3, the lock plate 31 is moved from the locked position to the unlocked position. At this time, since the output portion 32a of the link 32 is in contact with the manipulation portion 5b of the claw 5 from the horizontal direction, the link 32 cannot be moved to the manipulation portion 5b side, and the spring 35 is held in a compressed state. Also, the lock state detecting switch 18 pressed downward by the lifted joint 33 is switched from the ON state to the OFF state, and a lock switching signal is output to the control unit 20.

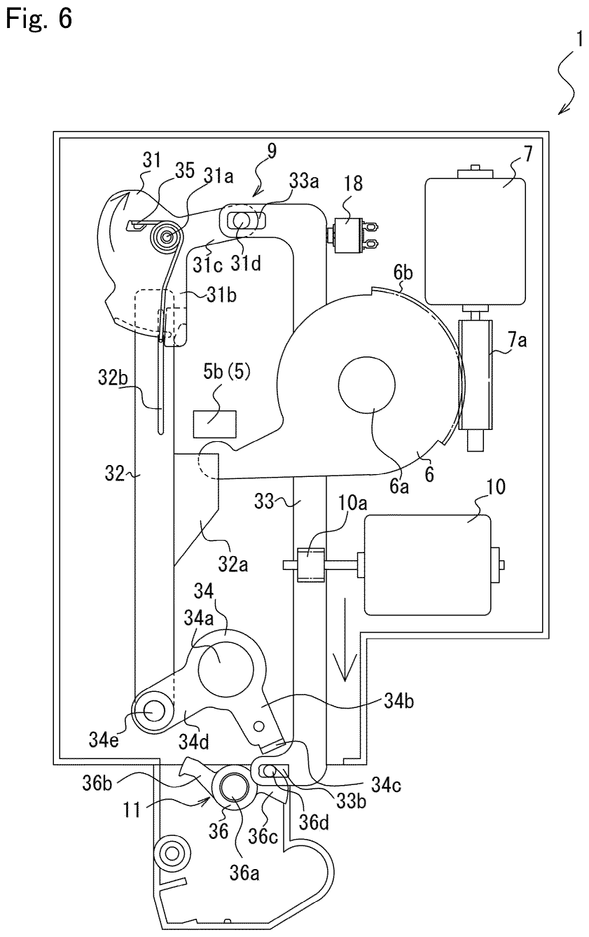

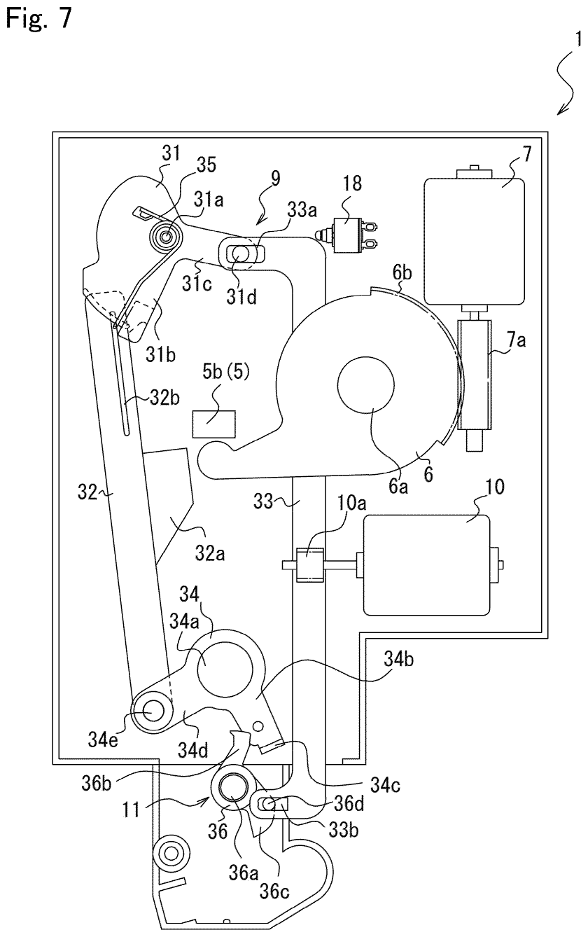

When the first pulling manipulation of the inner handle 8 is stopped in the state of FIG. 3, the inner opening lever 34 is rotated in the counterclockwise direction by a resilient biasing force, and the link 32 is lowered in response to the rotation thereof. Also, when the link 32 descends, the lateral engagement between the output portion 32a of the link 32 and the manipulation portion 5b of the claw 5 is released, and the link 32 moves in the unlock direction by a biasing force of the spring 35. As illustrated in FIG. 6, the lock plate 31 is in the unlocked position, and the output portion 32a is in a state of being aligned with the manipulation portion 5b of the claw 5 in the horizontal direction in FIG. 6, that is, in the unlocked state. In the state of FIG. 6, the control unit 20 drives the motor 10 for the lock mechanism to lower the joint 33, and as a result, as illustrated in FIG. 7, the lock plate 31 is moved from the unlocked position to the locked position, and the locking mechanism 9 are switched from the un locked state to the locked state.

A timing at which an electric child switching operation for moving the lock plate 31 from the unlocked position to the locked position by driving the motor 10 for the locking mechanism after the control unit 20 receives the lock switching signal is not limited thereto, and the electric child switching operation may be performed, for example, during the first pulling manipulation of the inner handle 8 or after the first pulling manipulation of the inner handle 8 is stopped. That is, it is preferable to perform the electric child switching operation immediately after the control unit 20 receives the lock switching signal so that the electric child switching operation is reliably performed before the second pulling manipulation of the inner handle 8.

As described above, at the time of the child lock state, the override function is disabled, and the locking mechanism 9 cannot be switched from the locked state to the unlocked state in response to the manipulation of the inner handle 8.

The control unit 20 drives the motor 10 for the locking mechanism and moves the lock plate 31 from the locked position to the unlocked position when receiving, from the lock state detecting switch 18, the lock switching signal indicating that the lock plate 31 has been moved from the locked position to the unlocked position by the override mechanism 11 in the child lock state in which the control unit 20 has received the child lock signal from the child lock switch 17. As described above, since the child lock mechanism is realized by controlling the motor 10 for the locking mechanism by the control unit 20, there is no need to provide a dedicated motor for the child lock mechanism. Hence, the child lock mechanism of the door latch apparatus 1 can be motorized while an increase in costs due to an increase in the number of components and intricacy of a structure is curbed.

The control unit 20 causes the alarm issuing unit 21 to issue an alarm when the lock switching signal is received from the lock state detecting switch 18 in the child lock state. When the alarm issuing unit 21 issues an alarm, it is possible to notify the occupant who intends to use the override mechanism 11 by manipulating the inner handle 8 that the override cannot be performed since the child lock state is set. That is, it is possible to notify the occupant who intends to use the override mechanism 11 by manipulating the inner handle 8 that the door latch apparatus 1 is normally operating since the child lock state does not allow the override to be performed even if the inner handle 8 is manipulated.

As described above, the override mechanism 11 is the two-motion override mechanism that realizes the switching of the lock plate 31 from the locked position (the locked state) to the unlocked position (unlocked state) and the disengagement of the claw 5 from the fork 4 in response to the manipulation of the inner handle 8 twice. There is always a certain time interval between the first manipulation and the second manipulation of the inner handle 8. Therefore, at the time of child lock, when the override mechanism 11 moves the lock plate 31 from the locked position to the unlocked position in response to the first manipulation of the inner handle 8, the control unit 20 having received the lock switching signal from the lock state detecting switch 18 drives the motor 10 for the locking mechanism and moves the lock plate 31 from the unlocked position to the locked position before the second manipulation of the inner handle 8. That is, since the override mechanism 11 is the two-motion override mechanism, the motor 10 for the locking mechanism can reliably function to perform the child lock.

When the control unit 20 receives the emergency signal from the emergency sensor 19, the control unit does not drive the motor 10 for the locking mechanism even when receiving the lock switching signal from the lock state detecting switch 18 in the child lock state, and the locking mechanism 9 is maintained in the unlocked state. Consequently, since in an emergency situation, the inner handle 8 is manipulated to reliably ensure opening of the door, safety can be improved.

The present disclosure is not limited to the above embodiment, and can be variously modified without departing from the gist of the present disclosure.

What is claimed is:

1. A door latch apparatus comprising:
a fork that disengageably holds a striker;
a claw that disengageably engages with the fork and enables an engaged state of the fork with the striker to be maintained;
an inner opening lever that is rotatable in conjunction with a manipulation of an inner handle;
a lock member movable between an unlocked position and a locked position;
a motor for a locking mechanism which is capable of causing the lock member to be switched to either the unlocked position or the locked position;
a lock member position detecting unit that directly or indirectly detects movement of the lock member from the locked position to the unlocked position and outputs a lock switching signal;
a link that operates in conjunction with the lock member, transmits a rotation force of the inner opening lever to the claw to enable the claw and the fork to be disengaged from each other when the lock member is located at the unlocked position, and is not capable of transmitting the rotation force of the inner opening lever to the claw when the lock member is located at the locked position;
an override mechanism that enables the lock member to be moved from the locked position to the unlocked position in response to rotation of the inner opening lever;
a child lock manipulation receiving unit that receives a selecting manipulation selecting use or non-use of a child lock mechanism, outputs a child lock signal when the received selecting manipulation is use of the child lock mechanism, and outputs a child unlock signal when the received selecting manipulation is non-use of the child lock mechanism; and
a control unit that is capable of receiving the child lock signal and the child unlock signal from the child lock manipulation receiving unit and capable of receiving the lock switching signal from the lock member position detecting unit, wherein
the control unit drives the motor for the locking mechanism and moves the lock member from the locked position to the unlocked position when the lock switching signal is received from the lock member position detecting unit in a child lock state in which the child lock signal has been received from the child lock manipulation receiving unit.

2. The door latch apparatus according to claim 1, comprising an alarm issuing unit, wherein
the control unit causes the alarm issuing unit to issue an alarm when the lock switching signal is received from the lock member position detecting unit in the child lock state in which the child lock signal is received from the child lock manipulation receiving unit.

3. The door latch apparatus according to claim 1, wherein
the override mechanism includes an override manipulation portion capable of manipulating the lock member from the locked position to the unlocked position in response to rotation of the inner opening lever,
when the lock member is located at the locked position, a first manipulation of the inner handle causes the override manipulation portion to move the lock member from the locked position to the unlocked position, and
after the first manipulation, in a child unlock state in which the control unit receives the child unlock signal from the child lock manipulation receiving unit, a second manipulation of the inner handle causes the rotation force of the inner opening lever to be transmitted to the claw so that the claw and the fork are disengaged from each other.

4. The door latch apparatus according to claim 1, comprising an emergency sensor that detects an emergency situation in which the manipulation of the inner handle needs to ensure disengagement of the claw from the fork and that outputs an emergency signal, wherein
when the control unit receives the emergency signal, the control unit does not drive the motor for the locking mechanism even when receiving the lock switching signal from the lock member position detecting unit in the child lock state.
